(19) United States
(12) Patent Application Publication
(10) Pub. No.: US 2005/0192790 A1
(43) Pub. Date: Sep. 1, 2005

(54) Serial communication system and serial communication local terminal

(76) Inventors: Kazuya Endo, Tokyo (JP); Tohru Nonaka, Tokyo (JP)

Correspondence Address: Richard P. Berg, Esq.;c/o LADAS & PARRY, Suite 2100, 5670 Wilshire Boulevard, Los Angeles, CA, 90036-5679, US

(21) Appl. No.: 10/837,035

(22) Filed: Apr. 30, 2004

(30) Foreign Application Priority Data
May 8, 2003 (JP) 2003-129809

(51) Int. Cl. G06F 9/455

(52) U.S. Cl. 703/25; 703/24

(57) ABSTRACT

The invention is provided to make interface logic unnecessary and simplify a control system in a serial communication system for putting a line connecting a CPU and a control IC into serial form. The serial communication system 1 of the present invention comprises a center terminal 10, connected to the CPU 50 via the CPU control bus, for converting at least the operation instructions from a parallel signal to a serial signal for transmission to the serial communication line 30, and a local terminal 20, connected to the center terminal 10 via the serial communication line 30, for reconverting at least the serially converted operation instructions back to a parallel signal for transmission to the control IC 60. The local terminal 20 comprises a CPU emulation controller 2 for providing the CPU control bus in a pseudo manner, and is connected to the control IC 60 via the pseudo CPU control bus provided by the CPU emulation controller 21.

### FIELD OF THE INVENTION

The present invention relates to a serial communication system and serial communication local terminal for use with the serial communication system, for making a connection line between a CPU and a control IC serial.

### BACKGROUND OF THE INVENTION

In recent years, serial communication systems for making a connection line between a CPU and a control IC serial have been proposed. The systems are installed between a CPU outputting operating instructions for a drive device (motor, LCD, etc.) and a control IC (motor control IC, LCD drive IC etc.) for performing drive control of a drive device according to operation instructions from a CPU. This type of system is disclosed in Japanese Patent Laid-open Publication No. 8-195682, for example. As a serial communication method adopting this type of serial communication system, there exists a method where one center terminal excercising control with regards to communication exists within a plurality of communication function terminals connected to a serial line, so that a plurality of other subordinate local terminals are controlled as a result of this center terminal controlling communication order etc.

Further, as a communication procedure (protocol) for the serial communication method, the procedure is provided where the minimum communication unit comprises the steps of sending instruction data to a local terminal having a prescribed communication address by a center terminal, carrying out prescribed processing according to received instruction data and sending response data by the local terminal of corresponding address, and receiving response data by the center terminal. The communication procedure is defined by returning this communication unit to the first local terminal after repeating this communication unit for the number of terminals. This communication procedure is referred to as cycle communication or cyclic communication because the communication unit is repeated in a prescribed cycle. The aforementioned communication addresses are provided to each local terminal in such a manner that the same communication address values do not overlap and are set, for example, using DIP switches on the local terminals.

FIG. 7 is a view illustrating a data bit string for serial communication. As shown in FIG. 7, the serial communication data bit string is equipped with a start bit, communication address, data (terminal control command plus data (including designation addresses for control use described later)) check code and stop bit. The start bit is a bit string for making known the start of data communication when a terminal sends data to a serial communication line, with data sampling starting at a terminal on a receive side in synchronization with this start bit. A communication address is a bit string designating which terminal of the plurality of terminals connected to the serial communication line it is wished to pass data to. The data is a data bit string passed over to the opposing side and also contained terminal control commands in the case of controlling a local terminal. A check code is a bit string for checking whether or not received data is correct, with only data determined to be correct being valid. Further, a stop bit is a bit string indicating completion of data communication.

When addresses and data in a parallel state are received from a CPU, the serial communication system described above converts this to the kind of serial data bit string shown in FIG. 7, for transmission to a serial communication line. Conversely, when a serial data bit string is received, addresses and data are separated from within this serial data bit string, converted back to parallel data, and outputted to the control IC. Further, in recent years, in addition to the aforementioned serial communication functions for typical I/O functions, terminals equipped with additional functions such as memory sharing functions etc. have also been proposed. This type of terminal is disclosed in Japanese Patent Laid-open Publication No.9-326808 and Japanese Patent Laid-open Publication No. 2002-73584, for example.

Next, a description is given of a serial communication system of the related art taking motor control as an example. FIG. 8 is a block view showing a serial communication system of the related art using a local terminal equipped with an I/O terminal function. The serial communication system 100 (center terminal 101 and local terminal 102) shown in FIG. 8 is provided between CPU 104 for outputting operation instructions for a motor 103 via a CPU control bus and a motor control IC 105 for controlling driving of the motor 103 according to the operation instructions, thereby providing a serial line connecting a CPU 104 and a motor control IC 105. Numeral 106 is a motor drive circuit operated according to output pulses of the motor control IC 105.

The motor control IC 105 is equipped with a CPU interface capable of being connected to a CPU control bus but in the case of connecting to the serial communication system 100, it is necessary to connect to the local terminal 102 via interface logic 107 (for example, FPGA). As a result, when a large number of motors 103 are controlled, the number of interface logic elements 107 becomes large, and this invites increases in cost. Further, with the aforementioned serial communication system, the bit number of the control data is limited by the number of I/O terminals of the local terminal 102 so that, for example, when a local terminal 102 equipped with an 8-bit I/O terminal function is employed, the control is control of eight-bit data, which is detrimental to versatility.

As shown in FIG. 9, a configuration for a serial communication system employing a local terminal equipped with a motor control function has been proposed. This serial communication system 200 (center terminal 201 and local terminal 202) is provided between a CPU 204 for outputting operation instructions for the motor 203 and a motor drive circuit 205 operated according to an output pulse of the local terminal 202 so as to provide the local terminal 202 with a motor control function. When this kind of serial communication system 200 is used, the motor control IC and the interface logic are unnecessary, and it is possible to simplify the motor control system. However, the control function added to the local terminal 202 is limited to use with typical drive devices such as motors and LCDs and adoption with control of other drive devices is not possible. Further, as it is not possible to expand control functions the local terminal possesses, the degree of freedom of the control system is restricted in that the number of motor shafts that can be controlled at the same time becomes fixed, for example.

It is an object of the present invention to provide a serial communication system and serial communication local terminal for putting a line connecting between the CPU and the control IC into serial form where not only is interface logic no longer necessary so that the construction of the control system becomes simpler and costs of the control system can be reduced, but also is it possible to connect to various types of control ICs, so as to contribute to superior versatility and expandability.

### SUMMARY OF THE INVENTION

A serial communication system of the present invention is provided between a CPU for outputting operation instructions for a drive device via a CPU control bus and a control IC for controlling driving of the drive device according to the operation instructions and the serial communication system put a line connecting between the CPU and the control IC into serial form. The serial communication system comprises a center terminal, connected to the CPU via the CPU control bus, for converting at least the operation instructions from a parallel signal to a serial signal for transmission to a serial communication line, and a local terminal, connected to the center terminal via the serial communication line, for reconverting at least the serially converted operation instructions back to a parallel signal for transmission to the control IC.

The local terminal further comprises a CPU emulation controller for providing the CPU control bus in a pseudo manner or virtually providing the CPU control bus, and is connected to the control IC via the pseudo or virtual CPU control bus provided by the CPU emulation controller.

In another aspect, the present invention relates to a serial communication local terminal characterized by functioning as a local terminal disclosed in the above-mentioned serial communication system.

### BRIEF DESCRIPTION OF THE DRAWINGS

FIG. 1 is a block view showing a configuration for a serial communication system;

FIG. 2 is a view illustrating a serial communication system communication method;

FIG. 3 is a block view showing a configuration for a center terminal;

FIG. 4 is a block view showing a configuration for the local terminal;

FIG. 5 is a view illustrating an operation example (writing) for the serial communication system;

FIG. 6 is a view illustrating an operation example (reading) for the serial communication system;

FIG. 7 is a view illustrating a data bit string for serial communication;

FIG. 8 is a block view showing a serial communication system of the related art using a local terminal equipped with an I/O terminal function; and

FIG. 9 is a block view showing a serial communication system of the related art using a local terminal equipped with a motor control function.

### DETAIL DESCRIPTION OF THE PREFERRED EMBODIMENTS

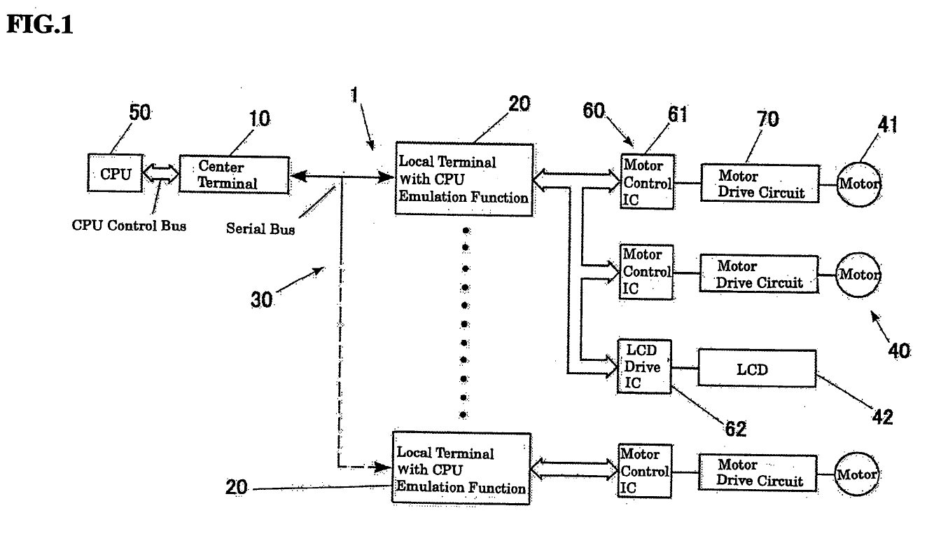

The following is a detailed description based on the drawings of a serial communication system exemplifying a preferred embodiment of the present invention. FIG. 1 is a block view showing a configuration for a serial communication system. As shown in FIG. 1, a serial communication system 1 comprises a single center terminal 10, a plurality of local terminals 20, and a serial communication line 30 connecting these together. The serial communication system 1 is provided between a CPU 50 for outputting operation instructions for a drive device 40 (motor 41, LCD 42, etc.) via a CPU control bus and a control IC 60 (motor control IC 61, LCD drive IC 62, etc.) for controlling driving of the drive device 40 according to the operation instructions, and puts a line connecting the CPU 50 and the control IC 60 into serial form. Numeral 70 is a motor drive circuit operating according to output pulses of the motor control IC 61.

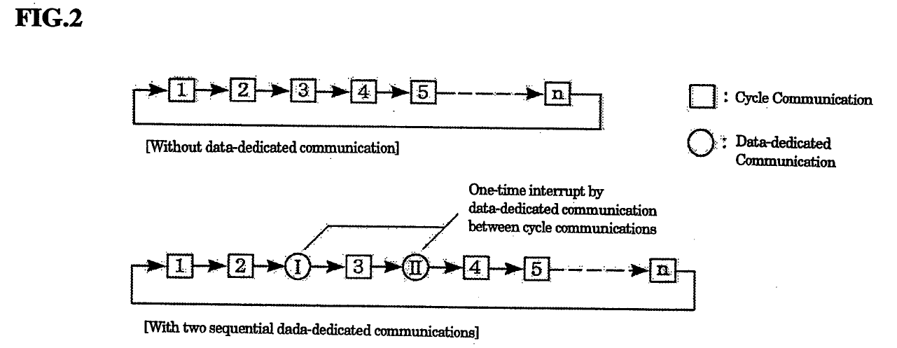

FIG. 2 is a view illustrating a serial communication system communication method. As shown in the drawings, the communication method for the serial communication system 1 comprises cycle communications (fixed data length) where the center terminal 10 sequentially transmits (or receives) fixed length data to each local terminal 20, and data-dedicated communications where the center terminal transmits (or receives) variable length data to prescribed local terminals 20 (CPU emulation terminals, described hereinafter). Cycle communications are always executed for data communication and status recognition and data-dedicated communication is executed by interrupting cycle communications as necessary. However, as there is a possibility that data-dedicated communication may be damaging to the cyclicity of cyclic communication, in this embodiment, the number of times data-dedicated communication performs interrupts between communication units of cycle communication is restricted to one time in the form of a one-time interrupt between cycle communications of a terminal 2 and a next terminal 3.

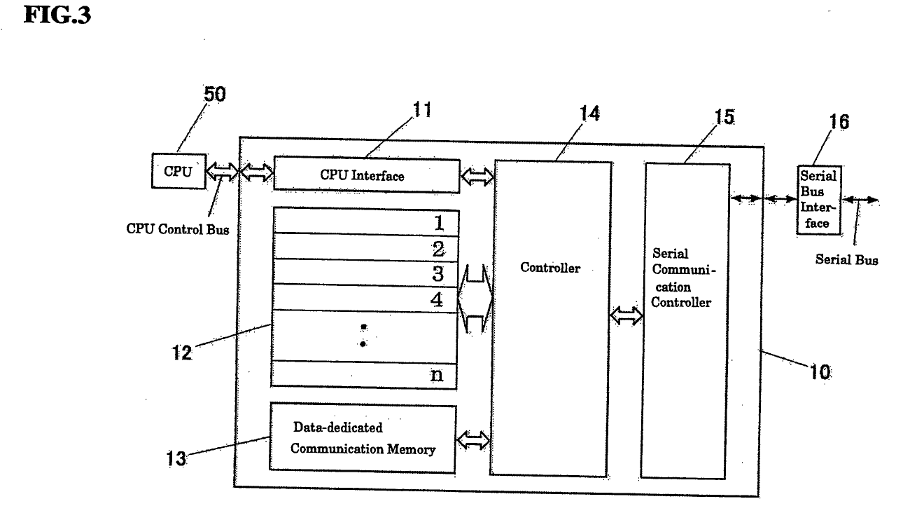

FIG. 3 is a block view showing a configuration for a center terminal. As shown in this drawing, the center terminal 10 is comprised of a CPU interface 11 connected to a CPU 50 via a CPU control bus, a cycle communication register group 12 for storing cycle communication transmission data and receive data, and status of the local terminal 20 having a CPU emulation function, a data-dedicated communication memory (FIFO) 13 for storing transmission data and receive data for data-dedicated communications, a controller 14 for carrying out data control and communication control, and a serial communication controller 15 for carrying out serial-parallel conversions.

In the case of carrying out data-dedicated communication, data is written to a transmission data region of the data-dedicated communication memory 13 from the CPU 50 via the CPU interface 11 and the controller 14. After this, writing of a command for starting data-dedicated communication is carried out. As a result, transmission data of the data-dedicated communication memory 13 is converted to a serial signal by the serial communication controller 15 via the controller 14 and transmitted to the serial communication line 30. The serial signal transmitted to the serial communication line 30 undergoes signal conversion at a serial bus interface 16 as necessary in order to convert to an electrical signal or optical signal appropriate for a serial bus.

Data-dedicated communication response receipt and reading of data from the local terminal 20 are carried out in reverse order to that described above. Data inputted to the center terminal 10 from the serial communication line 30 is stored in a receive region of the data-dedicated communication memory 13 via the serial communication controller 15 and the controller 14. When data input is complete, the controller 14 notifies the CPU 50 of completion of data input via the CPU interface 11. As a result, the CPU 50 is capable of reading out input data from the receive region of the data-dedicated communication memory 13 via the CPU interface 11 and controller 14.

The status of the local terminal 20 is stored in the cycle communication register group 12 at the time of responses for cycle communication and data-dedicated communication. By confirming this, it is possible to determine status confirmation and interrupt requests for the local terminal 20.

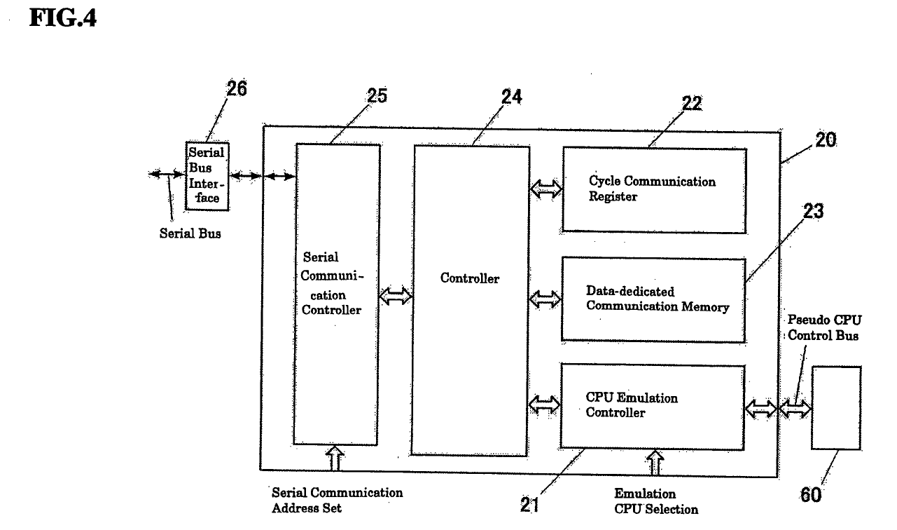

FIG. 4 is a block view showing a configuration for the local terminal. As shown in the drawing, the local terminal 20 is comprised of a CPU emulation controller 21 connected to a control bus (CPU peripheral LSI) 60 via a pseudo or virtual CPU control bus described hereinafter, a cycle communication register 22 storing transmission data and receive data for cycle communications, data-dedicated communication memory (FIFO) 23 storing transmission data and receive data for data-dedicated communications, a controller 24 for providing data control, data analysis and communication control and a serial communication controller 25 for carrying out serial-parallel conversion. Numeral 26 is a serial bus interface for carrying out signal conversion as necessary.

The CPU emulation controller 21 is configured so as to cause the control bus of the CPU 50 to be produced in a pseudo or virtual manner, and is connected to the control IC 60 via this pseudo or virtual CPU control bus. Specifically, portions of the control data for data inputted to the local terminal 20 are transmitted in the form of an output signal of the CPU 50 to the control IC 60 designated by the data control designation address portion, and data transmitted from the control IC 60 is capable of being inputted in the form of an input signal of the CPU 50. In this way, not only is it possible to connect the local terminal 20 and each type of control IC 60 directly without going via interface logic, but also it is possible to connect a plurality of control ICs 60 to one local terminal 20 using a bus.

A number of types of CPU control bus can be produced virtually by the CPU emulation controller 21, with typical CPU control buses being covered (CPU emulation means). The CPU emulation controller 21 comprises CPU selection means for selecting a CPU control bus to be produced from a plurality of types of CPU control bus, with the selected CPU control bus being produced in a pseudo or virtual manner. Selection by the CPU 50, selection using DIP switches, and automatic selection by bus analysis may be given as methods for selecting the CPU.

Data on the serial communication line 30 is inputted to all of the local terminals 20. In order to determine whether or not this data is addressed to itself, each local terminal 20 compares a address within the data and a preset communication address, and determine that the data is addressed to itself when these match. The controller 24 determines whether or not inputted data is cycle communication data, and determines whether or not this is data-dedicated communication data, and stores the inputted data distributed between the cycle communication register 22 and the data-dedicated communication memory 23. When the inputted data is of data-dedicated communications, the data content is analyzed, and the CPU emulation controller 21 is controlled according to this content. The data-dedicated communication is a variable-length data communication for enabling the CPU control bus to be produced in a pseudo-manner (virtually), and by describing the control data (operation instructions) and designation addresses to the plurality of control ICs 60 within this data, it is possible to exert control where the plurality of control ICs 60 connected to the local terminal 20 by bus are selected using a control address.

Namely, responses and output of data from the local terminal 20 to the center terminal 10 is carried out in the reverse order to that described above. Namely, the status of the local terminal 20 and data transmitted to the CPU 50 are stored so as to be distributed between transmission regions of the cycle communication register 22 and the data-dedicated communication memory 23 and these are then transmitted to the center terminal 10 via the controller 24 and the serial communication controller 25.

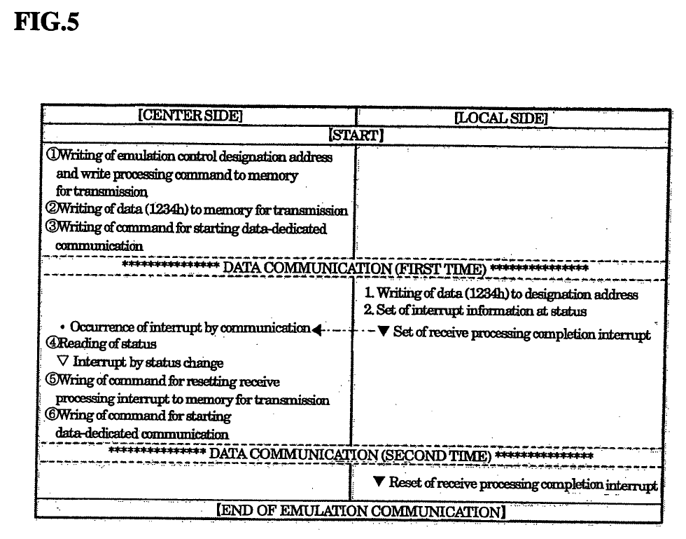

Next, a description is given of a specific operation example of the serial communication system 1. FIG. 5 is a view illustrating an operation example (writing) for the serial communication system. As shown in FIG. 5, when data “1234h” is written to the pseudo or virtual CPU control bus designation address, the CPU 50 writes the pseudo or virtual CPU control bus designation address and the write processing command to the data-dedicated communication memory 13. Next, the CPU 50 writes data “1234h” to the data-dedicated communication memory 13 and then carries out writing of commands to start data-dedicated communication. In this way, the center terminal 10 performs data-dedicated communication for the first time using the procedure described above, and transmits a designation address and data “1234h” for CPU emulation to a prescribed local terminal 20. In the writing process described above, there is taken to be one designation address but it is also possible for consecutive writing to take place for a plurality of designated addresses or for reading to take place consecutively from a plurality of designation addresses.

At the local terminal 20 receiving the designation address and data “1234h”, the data “1234h” is written to the designation address of the pseudo or virtual CPU control bus, and interrupt information is installed at the status regions of the cycle communication register 22 and the data-dedicated communication memory 23. When the status changes, a receive processing completion interrupt is set for the cycle communication or data-dedicated communication, and a status transmission is carried out to the center terminal 10. As described above, the status transmission processing can be executed for either the cycle communications or the data-dedicated communications. When it is possible to wait for the cycle communication cycle, changes in the status of the cycle communication are awaited, and when it is not possible to wait, polling processing may be carried out until the status of response data changes using an empty data-dedicated communication (NOP transmission).

At the center terminal 10 that receives the status from the local terminal 20, reading of the status is carried out by the CPU 50, and writing of a command to reset receive processing interrupt at the data-dedicated communication memory 13 is carried out. After his, when a command to start data-dedicated communication is written, a reset instruction is transmitted from the center terminal 10 to the local terminal 20 using the second data-dedicated communication, and the receive processing completion interrupt is reset at the local terminal 20.

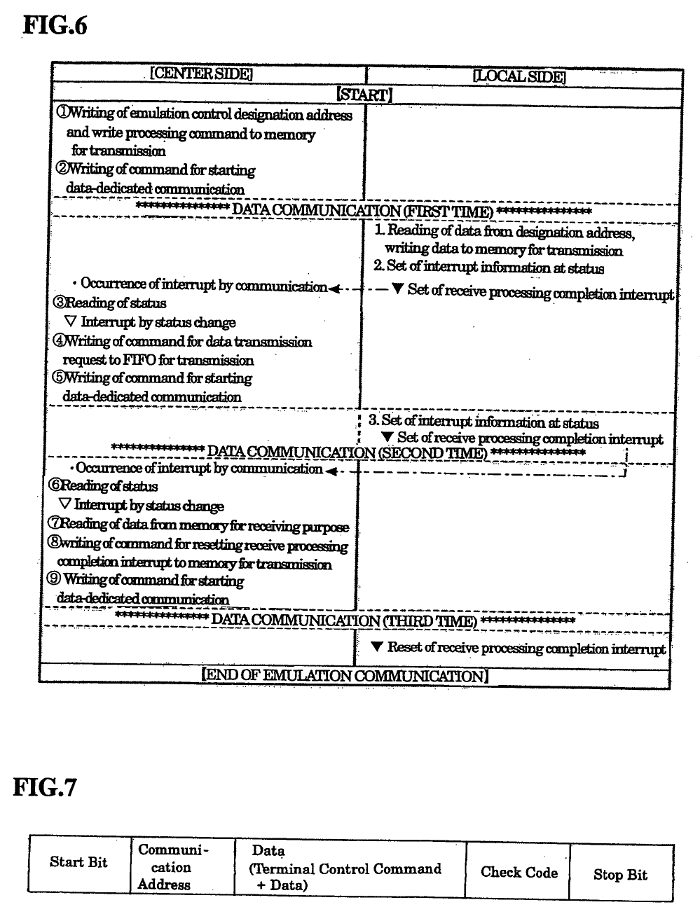

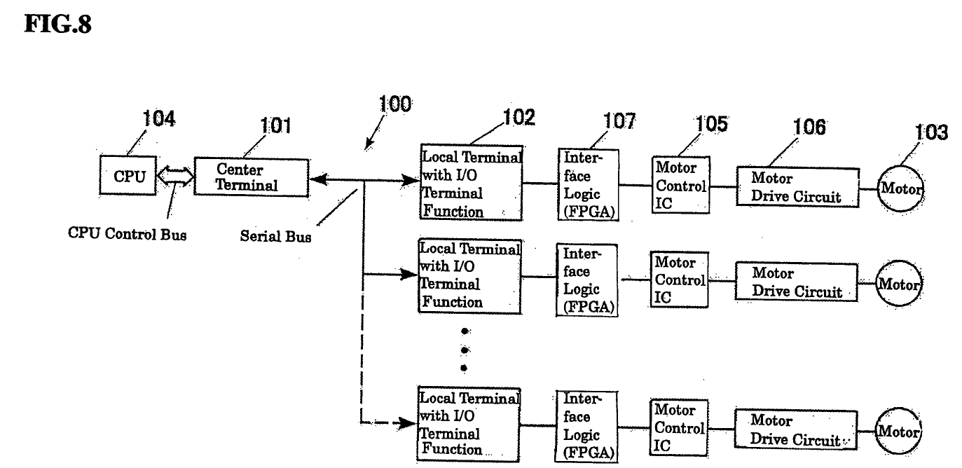

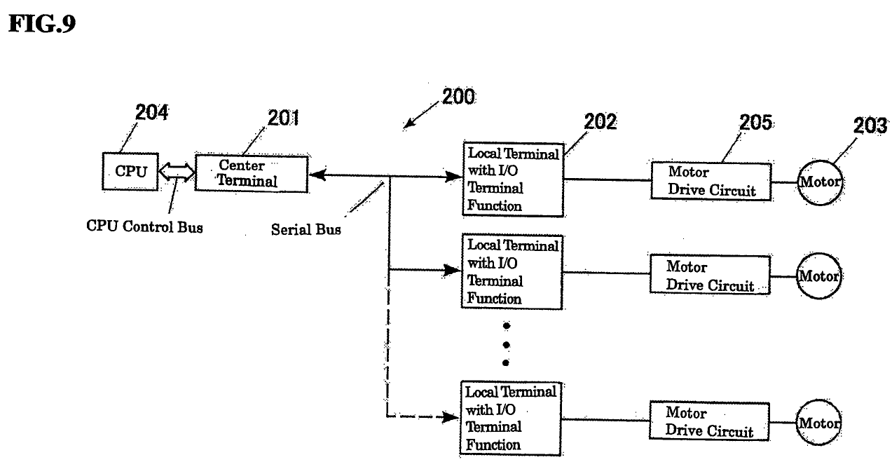

FIG. 6 is a view illustrating an operation example (reading) for the serial communication system. As shown in FIG. 6, when data is read out from the designation address of the pseudo or virtual CPU control bus, after writing designation address and read processing commands for the pseudo or virtual CPU control bus at the data-dedicated communication memory 13, the CPU 50 writes commands to start data-dedicated communication. As a result, the center terminal 10 performs data-dedicated communication for the first time and transmits the read-out control command and designation address to a prescribed local terminal 20.

At the local terminal 20 receiving the readout control command and designation address, data from the designation address for the pseudo or virtual CPU control bus is read out, this is written to the transmission region of the data-dedicated communication memory 23, and after this, interrupt information is set at the status regions of the cycle communication register 22 and the data-dedicated communication memory 23. When the status changes, a receive processing completion interrupt is set for the cycle communication or data-dedicated communication, and a status transmission is carried out to the center terminal 10.

At the center terminal 10 that receives the status from the local terminal 20, reading of the status is carried out by the CPU 50, and a command for a data transmission request is written to the data-dedicated communication memory 13. After this, when a command for starting data-dedicated communication is written, read data for the designation address and the status are transmitted from the local terminal 20 to the center terminal 10 using the second data-dedicated communication.

At the center terminal 10 that receives the read data and the status from the local terminal 20, reading of the status is carried out by the CPU 50, and reading of data from the receive region of the data-dedicated communication memory 13 is carried out. After this, when a command for resetting a receive processing completion interrupt is written to the data-dedicated communication memory 13 and a command to start data-dedicated communication is written, a reset instruction is transmitted from the center terminal 10 to the local terminal 20 and the receive processing completion interrupt for the local terminal 20 is reset.

In the embodiment of the present invention configured in the above manner, the serial communication system 1 is provided between a CPU 50 for outputting operation instructions for a drive device 40 via a CPU control bus and a control IC 60 for controlling driving of the drive device 40 according to the operation instructions, and puts a line connecting the CPU 50 and the control IC 60 into serial form. The serial communication system 1 of the present invention is configured from a center terminal 10, connected to the CPU 50 via the CPU control bus, for converting at least the operation instructions from a parallel signal to a serial signal for transmission to the serial communication line 30, and a local terminal 20, connected to the center terminal 10 via the serial communication line 30, for reconverting at least the serially converted operation instructions back to a parallel signal for transmission to the control IC 60. The local terminal 20 comprises a CPU emulation controller 21 for producing the CPU control bus in a pseudo or virtual manner, and is connected to the control IC 60 via the pseudo or virtual CPU control bus produced by the CPU emulation controller 21. Direct connection to each type of control IC 60 is therefore possible without passing via interface logic. As a result of this, connection is possible with various CPU peripheral LSIs such as motor control ICs corresponding to multi-axial control for bus connection use, pluralities of motor control ICs, data control ICs, counter control ICs, and LCD display control ICs. This means that it is not only possible to reduce the costs involved in control systems, but it is also possible to contribute to superior versatility and expandability Moreover, as it is possible for a large number of control ICs 60 to be connected in a plurality of parallel states (bus connections) to the CPU control bus, rather than providing the local terminals 20 and controller ICs 60 at a ratio of one to one, it is also possible for these to be provided at a one to N ratio, and the number of local terminals 20 provided can therefore be reduced.

The CPU emulation controller 21 is capable of virtually producing a plurality of types of CPU control bus, and the type of CPU control bus to be produced virtually can be arbitrarily selected. It is therefore possible to apply the serial communication system 1 of the present invention to control systems using each type of CPU 50 and to emulate a plurality of types of CPUs using one type of CPU.

The center terminal 10 carries out cycle communications of sequentially transmitting fixed length data to the plurality of local terminals 20 connected via the serial communication line 30, and executes data-dedicated communication to transmit variable length data so as to interrupt fixed length data cycle communications to a local terminal 20 that virtually produces the CPU control bus. The data for carrying out CPU emulation therefore ensures that the cyclic communications remain cyclic, and can be transmitted to the local terminal 20.

The serial communication system of the present invention is a serial communication system provided between a CPU 50 for outputting operation instructions for a drive device via a CPU control bus and a control IC 60 for controlling driving of the drive device 40 according to the operation instructions, for putting a line connecting between the CPU and the control IC into serial form, and the system comprises a center terminal 10, connected to the CPU 50 via the CPU control bus, for converting at least the operation instructions from a parallel signal to a serial signal for transmission to the serial communication line 3O, and a local terminal 20, connected to the center terminal 10 via the serial communication line 30, for reconverting at least the serially converted operation instructions back to a parallel signal for transmission to the control IC 60. The local terminal 20 comprises a CPU emulation controller 21 for virtually producing the CPU control bus, and is connected to the control IC 60 via the virtual CPU control bus made to reappear by the CPU emulation controller 21. In the serial communication system provided between a CPU 50 for outputting operation instructions for a drive device via a CPU control bus and a control IC 60 for controlling driving of the drive device according to the operation instructions, for putting a line connecting between the CPU and the control IC into serial form, by having local terminals of the serial communication system virtually provides the CPU control bus and connect to the control IC 60 via this pseudo or virtual CPU control bus, not only is interface logic no longer necessary so that costs of the control system can be reduced, but also is it possible to connect to various types of control ICs, so as to contribute to superior versatility and expandability.

1. A serial communication system for putting a line connecting between a CPU and a control IC into serial form, said system being provided between the CPU for outputting operation instructions for a drive device via a CPU control bus and the control IC for controlling driving of the drive device according to the operation instructions, said system comprising:
a center terminal, connected to the CPU via the CPU control bus, for converting at least the operation instructions from a parallel signal to a serial signal for transmission to a serial communication line; and
a local terminal, connected to the center terminal via the serial communication line, for reconverting at least the serially converted operation instructions back to a parallel signal for transmission to the control IC,
wherein the local terminal comprises a CPU emulation controller producing the CPU control bus in a pseudo manner, and is connected to the control IC via the pseudo CPU control bus produced by the CPU emulation controller.

2. The serial communication system of claim 1, wherein the CPU emulation controller comprises CPU emulation means for producing a plurality of types of CPU control bus in a pseudo manner, and CPU selection means for selecting the type of CPU control bus to be produced in a pseudo manner.

3. The serial communication system of claim 1, wherein the center terminal carries out cycle communications of sequentially transmitting fixed length data to the plurality of local terminals connected via the connection line, and transmits variable length data so as to interrupt fixed length data cycle communications to a local terminal producing the CPU control bus in a pseudo manner.

4. The serial communication system of claim 2, wherein the center terminal carries out cycle communications of sequentially transmitting fixed length data to the plurality of local terminals connected via the connection line, and transmits variable length data so as to interrupt fixed length data cycle communications to a local terminal producing the CPU control bus in a pseudo manner.

5. A serial communication system for putting a line connecting between a CPU and a control IC into serial form, said system being provided between the CPU for outputting operation instructions for a drive device via a CPU control bus and the control IC for controlling driving of the drive device according to the operation instructions, said system comprising:
a center terminal, connected to the CPU via the CPU control bus, for converting at least the operation instructions from a parallel signal to a serial signal for transmission to a serial communication line; and
a local terminal, connected to the center terminal via the serial communication line, for reconverting at least the serially converted operation instructions back to a parallel signal for transmission to the control IC, said local terminal further comprising a CPU emulation controller for virtually generating the CPU control bus, and said local terminal being connected to the control IC via the virtual CPU control bus generated by the CPU emulation controller.

6. The serial communication system of claim 5, wherein the CPU emulation controller comprises CPU emulation means for virtually generating a plurality of types of CPU control bus, and CPU selection means for selecting the type of CPU control bus to be generated virtually.

7. The serial communication system of claim 5, wherein the center terminal carries out cycle communications of sequentially transmitting fixed length data to the plurality of local terminals connected via the connection line, and transmits variable length data so as to interrupt fixed length data cycle communications to a local terminal virtually generating the CPU control bus.

8. The serial communication system of claim 6, wherein the center terminal carries out cycle communications of sequentially transmitting fixed length data to the plurality of local terminals connected via the connection line, and transmits variable length data so as to interrupt fixed length data cycle communications to a local terminal virtually generating the CPU control bus.

9. A serial communication local terminal for use in constructing a serial communication system for providing a line connecting between a CPU and a control IC into serial form, said system being provided between the CPU for outputting operation instructions for a drive device via a CPU control bus and the control IC for controlling driving of the drive device according to the operation instructions, and the system comprising a center terminal and a local terminal, the center terminal being connected to the CPU via the CPU control bus, for converting at least the operation instructions from a parallel signal to a serial signal for transmission to a serial communication line,
wherein said local terminal is connected to the center terminal via the serial communication line, for reconverting at least the serially converted operation instructions back to a parallel signal for transmission to the control IC, said local terminal further comprises a CPU emulation controller for virtually generating the CPU control bus, and is connected to the control IC via the virtual CPU control bus generated by the CPU emulation controller.

10. The serial communication local terminal of claim 9, wherein the CPU emulation controller comprises CPU emulation means for virtually producing a plurality of types of CPU control bus, and CPU selection means for selecting the type of CPU control bus to be produced virtually.

11. The serial communication local terminal of claim 9, the center terminal carries out cycle communications of sequentially transmitting fixed length data to the plurality of local terminals connected via the connection line, and transmits variable length data so as to interrupt fixed length data cycle communications to a local terminal virtually producing the CPU control bus.
